(19) United States
(12) Patent Application Publication
(10) Pub. No.: US 2011/0178675 A1
(43) Pub. Date: Jul. 21, 2011

(54) METHOD AND DEVICE FOR LOCATING THE LONGITUDINAL POSITION OF THE WHEELS OF A VEHICLE

(75) Inventors: Youri Vassilieff, Toulouse (FR); Thomas Haas, Donaustauf (DE); Jeremy Armengaud, Saverdun (FR)

(73) Assignees: CONTINENTAL AUTOMOTIVE FRANCE, Toulouse (FR); CONTINENTAL AUTOMOTIVE GMBH, Hannover (DE)

(21) Appl. No.: 13/063,559

(22) PCT Filed: Aug. 21, 2009
(86) PCT No.: PCT/EP2009/006076

§ 371 Date: Apr. 6, 2011

(30) Foreign Application Priority Data
Sep. 16, 2008 (FR) 0805078

(51) Int. Cl. G06F 19/00

(52) U.S. Cl. 701/29

(57) ABSTRACT

A method for locating the longitudinal position of wheels (2, 3, 5, 6) of a vehicle (1) in which each wheel is fitted with a tangential measurement sensor (16) suitable for delivering measurement signals including a carrier of amplitudes and frequencies that are a function of the vibratory impacts sustained by the tangential measurement sensor. According to the invention, also, the amplitudes of the carrier of the signals in a frequency band corresponding to the frequencies of the explosions of the engine (M) are measured, the signals are compared so as to identify the signals of which the carriers have, for identical frequencies, maximum amplitudes, and the wheels (2, 3) that are the source of the signals of which the carriers have maximum amplitudes are located as corresponding to the wheels (2, 3) mounted on the driveshaft (4).

The invention relates to a method for locating the longitudinal position, either on the front set or on the rear set of a motor vehicle, on wheels fitted with an electronic module suitable for transmitting, to a central unit mounted on the vehicle, signals representative of operating parameters of each wheel also comprising a code for identifying the latter.

More and more motor vehicles have, for safety purposes, monitoring systems comprising sensors mounted on each of the wheels of the vehicle, which sensors are dedicated to the measurement of parameters, such as pressure or temperature, of the tires fitted to these wheels, and designed to inform the driver of any abnormal variation of the measured parameter.

These monitoring systems are conventionally furnished with an electronic module mounted on each of the wheels of the vehicle incorporating, in addition to the aforementioned sensors, a microprocessor and a radiofrequency transmitter, and with a central unit (mounted on the vehicle) and making possible the reception of the signals transmitted by the transmitters, this central unit comprising a computer incorporating a radiofrequency receiver connected to an antenna.

One of the problems that need solving for such monitoring systems lies in the obligation to associate with each signal received by the receiver of the central unit an item of information concerning the location of the electronic module and therefore of the wheel that is the source of this signal, this obligation lasting throughout the service life of the vehicle, that is to say having to be complied with even after wheel changes or more simply inversions of the position of these wheels.

Currently, a first location method consists in incorporating an accelerometer into each electronic module and in applying a location technique based on statistical methods consisting in comparing the accelerations of the various wheels in order to obtain an item of information on the respective position of each of said wheels of the vehicle.

This location method is however not very efficient because it requires a considerable running time to achieve a discrimination between the various wheels.

A second location method consists in using three low-frequency antennas each positioned close to one of the wheels of the vehicle, and in carrying out a location procedure consisting in successively exciting each of these three antennas by the transmission of a low-frequency magnetic field.

According to this procedure, the electronic module mounted on the wheel situated close to the excited antenna transmits, in response to and in the direction of the central unit, a signal comprising a code for identifying said module, so that the successive excitation of the three antennas results in the location of the three electronic modules mounted on the wheels next to these antennas, and by deduction, in the location of the fourth module.

The main advantage of such a method lies in the fact that the location procedure is very rapid and results in a virtually instantaneous location after the vehicle has started.

However, this solution makes it necessary to fit the vehicle with three antennas with all the relevant constraints: connection cables, control amplifiers, etc., and thus proves to be costly.

The object of the present invention, for its part, is a third method dedicated to the location of the longitudinal position (front set or rear set) of the wheels of a vehicle, and its main objective is to provide a very efficient location method in terms of responsiveness and reliability.

Accordingly, the subject of the invention is a method for locating the longitudinal position, either on the front set, or on the rear set, of wheels of a vehicle furnished with an engine for driving a driveshaft, said wheels being fitted with an electronic module suitable for transmitting, to a central unit mounted on the vehicle, signals representative of operating parameters of each wheel also comprising a code for identifying the latter.

According to the invention, and in the first place, incorporated into each electronic module is a sensor, called a tangential measurement sensor, having an axis of maximum tangential sensitivity, suitable for delivering measurement signals comprising a carrier of amplitudes and frequencies that are a function of the vibratory impacts sustained by the tangential measurement sensor.

Moreover, the location procedure consists, according to the invention, in measuring the amplitudes of the carrier of the signals delivered by the tangential measurement sensors in a frequency band corresponding to the frequencies of the explosions of the engine, in comparing said signals so as to identify the signals of which the carriers have, for identical frequencies, maximum amplitudes, and in locating the wheels, fitted with the tangential measurement sensors, that are the source of the signals of which the carriers have maximum amplitudes, as corresponding to the wheels mounted on the driveshaft.

In the first place, the intention is to define, by tangential measurement sensor, a measurement sensor of the tangential accelerometer type in particular, an impact sensor, positioned on a wheel so that its axis of maximum sensitivity extends in a plane orthogonal to the axis of rotation of the wheel and tangentially to the circumference of said wheel.

The invention has consisted in revealing that:
the vibrations resulting from the explosions of a vehicle engine are perceived as impacts by the tangential measurement sensors fitted to the wheels of the vehicle,
the signals representative of these vibrations have, for identical frequencies, similar amplitudes for two tangential measurement sensors fitted to the wheels mounted on one and the same set, front or rear,
and the signals representative of these vibrations have, for identical frequencies, different amplitudes capable of making it possible to distinguish the longitudinal position of the tangential measurement sensors.

Therefore, for example, in the case of a conventional two-wheel-drive vehicle, these vibrations can really be perceived only by the tangential measurement sensors fitted to the wheels mounted on the driveshaft of the vehicle, so that the method according to the invention results in an immediate discrimination between wheels mounted on the driveshaft and wheels mounted on the driven shaft, or in other words in an immediate discrimination concerning the longitudinal position of said wheels. (It should be noted that “driveshaft” means the shaft most directly engaged with the engine of the vehicle.)

The invention also applies to specific vehicles such as four-wheel-drive vehicles. However, the discrimination may then require a preliminary calibration step for the purpose of distinguishing the signals delivered by tangential measurement sensors positioned on different sets.

Such a technique is extremely efficient in terms of responsiveness because it results in a virtually immediate location of the longitudinal position of the wheels following the starting of the engine.

Advantageously, according to the invention, use is made of tangential measurement sensors suitable for delivering measurement signals resembling modulated signals consisting of the superposition of a sine-wave modulating signal with a frequency equal to the frequency of rotation of the wheel and of the carrier of amplitudes and frequencies as a function of the vibratory impacts sustained.

Such tangential measurement sensors, which may for example consist in tangential accelerometers, have the advantage of supplying modulated signals of which the values of the modulating signal are representative of the values of gravity, and of which the frequency, equal to the frequency of rotation of the wheels, makes it possible to calculate the rotation speed of said wheels.

Such additional items of information make it possible notably to increase the responsiveness and reliability of the location method according to the invention.

Therefore, in the first place, on the basis of the additional data supplied by these tangential measurement sensors, and according to one advantageous embodiment of the invention, in each electronic module:
the variations of the values of the sine-wave modulating signal of the modulated signal delivered by the tangential measurement sensor are analyzed, and measurement ranges of the amplitudes of the carrier of said modulated signal corresponding to ranges of values of said sine-wave modulating signal close to zero values are selected,
and, from the signals delivered by each tangential measurement sensor in these measurement ranges, the signals of which the carriers have the maximum amplitudes that correspond to a positioning of the electronic module in the vicinity of the top generatrix of the wheel are selected.

This embodiment results, in the first place, in taking the measurements only when the electronic module is positioned in the vicinity of the top generatrix or of the bottom generatrix of the wheel (zero values of the modulating signal that are representative of zero values of gravity).

Moreover, only the signals of maximum amplitude corresponding to a position of each electronic module in the vicinity of the top generatrix of a wheel are then taken into account by the central unit.

The advantage of such an embodiment lies in the fact that this wheel portion (top generatrix) is the portion sustaining the vibrations that are the greatest and therefore the most perceptible.

Moreover, the vibrations of this wheel portion are not influenced and disrupted by the vibrations of the suspensions which take place vertically and therefore have a zero tangential component at the top generatrix of the wheel.

According to another advantageous embodiment of the invention permitted by the use of tangential measurement sensors suitable for delivering measurement signals comprising a modulating signal:
in a prior phase, in each electronic module, for each transmission ratio of the gearbox of the engine of the vehicle, a frequency band is stored that is determined as a function of the value of said transmission ratio,
and when the vehicle is running, the rotation speed of each wheel is computed so as to determine the corresponding transmission ratio of the gearbox, and the associated frequency band is selected for the purpose of measuring the amplitudes of the carrier of the signals delivered by the tangential measurement sensors.

This embodiment dispenses with the need to make use of Fourier transforms, which require considerable computing power, by virtue of selecting frequency bands determined as a function of the rotation speed of the wheels and therefore of the transmission ratio of the gearbox.

Specifically, the ratio between the speed or the frequency of rotation of a wheel and the explosions of the engine is constant for a given transmission ratio of the gearbox. Therefore, the determination of the rotation speed of a wheel, by measuring the period of the sine-wave modulating signal representative of the values of gravity, makes it possible to select the appropriate frequency band amongst those predetermined for each transmission ratio of the gearbox.

According to another advantageous embodiment of the invention, the radial acceleration of each wheel is computed so as to command measurements of the amplitudes of the carrier of the signals delivered by the tangential measurement sensors only when said radial acceleration increases.

This arrangement results in taking the measurements only when the vehicle accelerates, that is to say when the engine is under load, and therefore when the amplitude of the sustained vibrations is maximal.

This radial acceleration can be computed on the basis of the measurement readings taken by the tangential measurement sensors. As a variant, and in order to reduce the required computing power, the radial acceleration of each wheel is advantageously computed by means of a measurement sensor having an axis of maximum radial sensitivity.

It should moreover be noted that the operations detailed above, advantageously applied according to the invention:
selection of measurement ranges corresponding to zero values of gravity,
selection of a frequency band for the measurement of the amplitudes,
and commanding of measurements only when the radial acceleration increases,
   are carried out in the electronic modules situated on the wheels, so that the signals delivered by the tangential measurement sensors sustain, before being transmitted to the central unit, a process which results in transmitting only the most pertinent data possible.

The “transmission” item of the electronic modules is the most demanding in terms of cost of the hardware elements and in power consumption. Consequently, these specifics, which are reflected in an optimal reduction of the transmitted data, make it possible to reduce the cost of the electronic modules considerably. Moreover, this optimization also results in a notable reduction in the “electronic pollution” generated.

Moreover, in order to ensure that the location method has maximum reliability, and advantageously according to the invention, values representative of the rotation speed of the engine are measured and said measured values are compared with values representative of the frequency of the carrier of the signals delivered by the tangential measurement sensors, so as to make the validation of said signals conditional upon a correlation between the compared values.

From the same viewpoint of reliability, and according to another advantageous embodiment of the invention, values representative of the load of the engine are measured and said measured values are compared with values representative of the amplitude of the carrier of the signals delivered by the tangential measurement sensors, so as to make the validation of said signals conditional upon a correlation between the compared values.

Other features, objects and advantages of the invention will emerge from the following detailed description, with reference to the appended drawings, which represent, as a nonlimiting example, a preferred embodiment thereof. In these drawings:

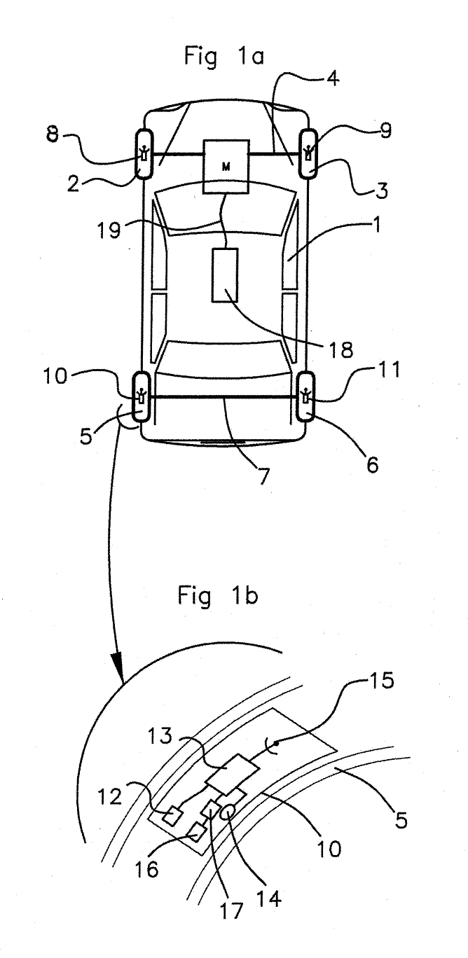

FIG. 1a is a schematic top view of a vehicle provided with a monitoring system associated with a device according to the invention for locating the longitudinal position of the wheels of said vehicle,

FIG. 1b is a schematic detail view in perspective representing a wheel portion of this vehicle and the electronic module fitted to the latter,

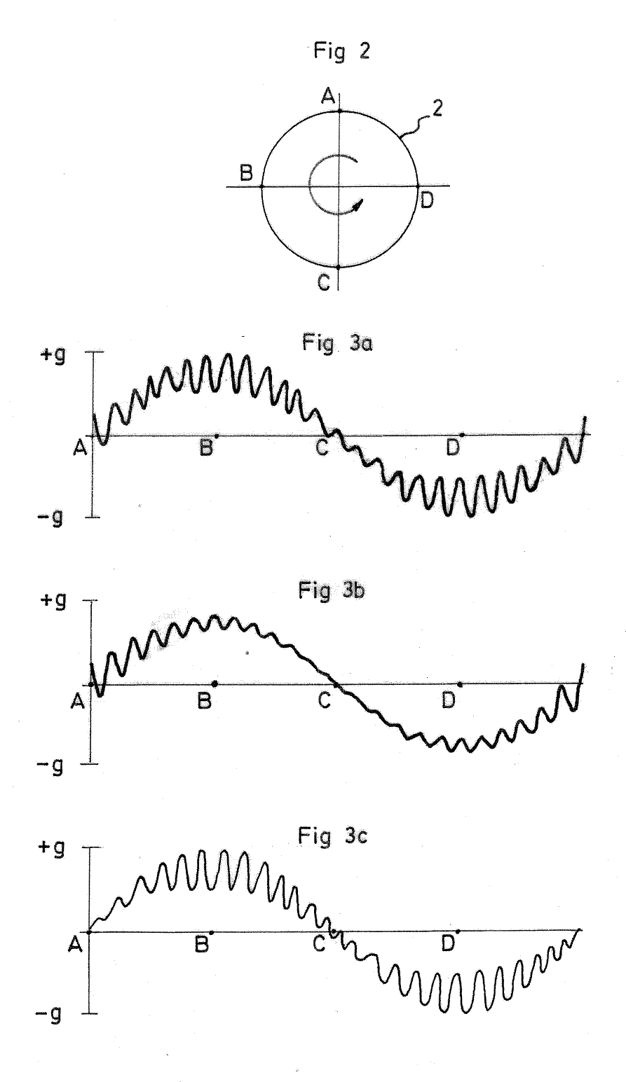

FIG. 2 is a schematic representation of a vehicle wheel on which are referenced the coordinates mentioned on the X axis on the curves 3a to 3c,

FIG. 3a is a curve representative of the modulated signal as delivered by a tangential measurement sensor according to the invention,

FIG. 3b is a curve representative of the portion of this modulated signal generated by the vibrations resulting from the explosions of a vehicle engine,

and FIG. 3c is a curve representative of the portion of the modulated signal generated by the vibrations of the suspensions of a vehicle.

The location device according to the invention shown as an example in FIGS. 1a and 1b is designed to locate the longitudinal position (front wheel or rear wheel) of the wheels of a vehicle.

This location device is more specifically designed to be installed on vehicles furnished with a monitoring system such as that, shown in FIG. 1a, fitted to a two-wheel-drive vehicle 1 furnished with an engine M and furnished with four wheels conventionally fitted with a tire: two front wheels 2, 3 mounted on the driveshaft 4 and two rear wheels 5, 6 mounted on the driven shaft 7.

Such monitoring systems conventionally comprise, in the first place, associated with each wheel 2, 3, 5, 6, an electronic module 8-11, for example secured to the rim of said wheel so as to be positioned inside the casing of the tire.

Each of these electronic modules 8-11 incorporates, for example, sensors 12 dedicated to measuring parameters, such as pressure and/or temperature of the tire, connected to a computing unit 13 with a microprocessor powered electrically by means of a button cell 14 and connected to an RF transmitter connected to a high-frequency antenna 15.

The monitoring system also comprises a central computer or central unit 18 situated in the vehicle 1, comprising a microprocessor and incorporating an RF receiver capable of receiving the signals transmitted by each of the four electronic modules 8-11.

Moreover, this central unit 18 is connected, in conventional manner, via a computer network 19, such as the “CAN” network, of the vehicle 1, to means (not shown) for measuring operating parameters such as rotation speed of the engine M, load of the engine M, instantaneous fuel consumption, etc.

Normally, such a monitoring system and notably its central unit 18 are designed so as to inform the driver of any abnormal variation in the parameters measured by the sensors 12 fitted to the wheels 2, 3, 5, 6.

Forming an integral part of this monitoring system, the function of the location device according to the invention is to make it possible to associate with each signal received by the central unit 18 an item of information concerning the longitudinal position of the wheel 2, 3, 5, 6 fitted with the electronic module 8-11 that is the source of this signal.

Accordingly, this location device comprises a measurement sensor 16, of the accelerometer type, incorporated into each electronic module 8-11 and placed so as to have an axis of maximum tangential sensitivity, so as to deliver measurement signals resembling modulated signals consisting of the superposition of a sine-wave modulating signal with a frequency equal to the frequency of the rotation of the wheel and of a carrier of amplitudes and frequencies that are a function of the vibratory impacts sustained by the tangential measurement sensor 16 and resulting from the explosions of the engine M of the vehicle 1.

The particular features of the carriers of the signals delivered by such tangential accelerometers 16 are as follows:
these carriers have, for identical frequencies, similar amplitudes for two tangential measurement sensors 16 fitted to wheels 2-3 and 5-6 mounted on one and the same axle, drive axle 4 or driven axle 7,
and these carriers have, for identical frequencies, different amplitudes capable of making it possible to determine the longitudinal position of the tangential measurement sensors 16. For a vehicle 1 as shown, with two front drive wheels 2, 3, the amplitudes of the carriers originating from the sensors 16 mounted on these drive wheels 2, 3 are therefore much greater than those of the carriers originating from the sensors 16 mounted on the driven wheels 5, 6.

These particular features make it possible to apply a location procedure consisting:
in measuring the amplitudes of the carrier of the signals delivered by the tangential measurement sensors 16 in a frequency band corresponding to the frequencies of the explosions of the engine M,
in comparing said signals so as to identify the signals of which the carriers have, for identical frequencies, maximum amplitudes,
and in locating the wheels 2, 3 fitted with the tangential measurement sensors 16 that are the source of the signals of which the carriers have maximum amplitudes, as corresponding to the wheels 2, 3 mounted on the driveshaft 4.

Moreover, during this location procedure:
in the first place, measurement ranges of the amplitudes of the carrier of the modulated signal corresponding to ranges of values of the sine-wave modulating signal close to zero values are selected,
then, in the second place, from these measurement ranges, those corresponding to the signals of which the carriers have the maximum amplitudes are selected.

If reference is made to FIG. 3a which represents a period of the modulated signal delivered by a tangential measurement sensor 16, the null values (the criterion of the first selection) are obtained for the ranges close to the X-axis points A and C that correspond to the top generatrix (point A) and bottom generatrix (point C) of the wheel 2. The choice, from the measurement ranges thus selected, of the ranges having maximum values (the second selection criterion) then results in selecting the zone close to point A.

In point of fact, if the modulated signal is divided into a signal representative of the vibrations resulting from the explosions of the engine M of the vehicle 1 (FIG. 3b) and into a signal representative of the vibrations of the suspensions of the vehicle 1 (FIG. 3c), it is found that:
the signal of FIG. 3b is maximal at A (top generatrix) and minimal at C (bottom generatrix),
the signal of FIG. 3c is minimal at A and C.

Therefore, this double selection results in selecting the wheel portion (top generatrix), on the one hand, sustaining the vibrations resulting from the explosions of the engine M that are the greatest, and therefore the most perceptible, and, on the other hand, the least influenced and disrupted by the vibrations of the suspensions.

The sine-wave modulating signals also have a frequency equal to the frequency of rotation of the associated wheel 2, 3, 5, 6.

The analysis of these modulating signals therefore also makes it possible to compute the rotation speed of each wheel 2, 3, 5, 6, to deduce therefrom the corresponding transmission ratio of the gearbox and, consequently, to determine the corresponding range of the frequencies of the explosions of the engine M, and to select this frequency band for the purpose of measuring the amplitudes of the carrier of the signals delivered by the tangential measurement sensors 16.

Optionally, the location device may also comprise a radial measurement sensor 17, of the radial accelerometer type, making it possible to compute the radial acceleration of each wheel 2, 3, 5, 6.

Such a radial accelerometer 17 makes it possible to command the measurements of the amplitudes of the carrier of the signals delivered by the tangential measurement sensors 16 only when the radial acceleration increases, that is to say when the engine M is under load, and therefore when the amplitude of the vibrations sustained is maximal.

Moreover, the acquisition by the central unit 18, via the computer network 19, of operating parameters such as rotation speed of the engine M, load of the engine M, instantaneous fuel consumption, makes it possible to confer maximum reliability on the location method according to the invention.

It is therefore possible to acquire values representative of the rotation speed of the engine M for the purpose of comparing said values with the values representative of the frequency of the carrier of the signals delivered by the tangential measurement sensors 16, and then to make the validation of said signals conditional upon a correlation between the compared values.

As a variant, it is also possible to acquire values representative of the load of the engine M for the purpose of comparing said measurement values with values representative of the amplitude of the carrier of the signals delivered by the tangential measurement sensors 16, and then to make the validation of said signals conditional upon a correlation between the compared values.

The location method according to the invention described above therefore makes it possible, subject to installing a simple tangential accelerometer 16, and optionally a radial accelerometer 17, in each electronic module 8-11 installed on a wheel 2, 3, 5, 6 of a vehicle 1, to very rapidly and reliably locate the longitudinal position of said wheel.

1. A method for locating the longitudinal position, either on the front set, or on the rear set, of wheels (2, 3, 5, 6) of a vehicle (1) furnished with an engine (M) for driving a driveshaft (4), said wheels being fitted with an electronic module (8-11) suitable for transmitting, to a central unit (18) mounted on the vehicle (1), signals representative of operating parameters of each wheel (2, 3, 5, 6) also comprising a code for identifying the latter, said location method comprising:
incorporating, into each electronic module (8-11), a sensor (16), called a tangential measurement sensor, having an axis of maximum tangential sensitivity, suitable for delivering measurement signals comprising a carrier of amplitudes and frequencies that are a function of the vibratory impacts sustained by the tangential measurement sensor (16),
measuring the amplitudes of the carrier of the signals delivered by the tangential measurement sensors (16) in a frequency band corresponding to the frequencies of the explosions of the engine (M),
comparing said signals so as to identify the signals of which the carriers have, for identical frequencies, maximum amplitudes,
and locating the wheels (2, 3), fitted with the tangential measurement sensors (16), that are the source of the signals of which the carriers have maximum amplitudes, as corresponding to the wheels (2, 3) mounted on the driveshaft (4).

2. The location method as claimed in claim 1, characterized in that use is made of tangential measurement sensors (16) suitable for delivering measurement signals resembling modulated signals consisting of the superposition of a sine-wave modulating signal with a frequency equal to the frequency of rotation of the wheel (2, 3, 5, 6) and of the carrier of amplitudes and frequencies as a function of the vibratory impacts sustained.

3. The location method as claimed in claim 2, characterized in that, in each electronic module (8-11):
the variations of the values of the sine-wave modulating signal of the modulated signal delivered by the tangential measurement sensor (16) are analyzed, and measurement ranges of the amplitudes of the carrier of said modulated signal corresponding to ranges of values of said sine-wave modulating signal close to zero values are selected,
and, from the signals delivered by each tangential measurement sensor (16) in these measurement ranges, the signals of which the carriers have the maximum amplitudes that correspond to a positioning of the electronic module (8-11) in the vicinity of the top generatrix of the wheel (2, 3, 5, 6) are selected.

4. The location method as claimed in claim 2, characterized in that:
in a prior phase, in each electronic module (8-11), for each transmission ratio of the gearbox of the engine (M) of the vehicle (1), a frequency band is stored that is determined as a function of the value of said transmission ratio,
and when the vehicle (1) is running, the rotation speed of each wheel (2, 3, 5, 6) is computed so as to determine the corresponding transmission ratio of the gearbox, and the associated frequency band is selected for the purpose of measuring the amplitudes of the carrier of the signals delivered by the tangential measurement sensors (16).

5. The location method as claimed in claim 1, characterized in that the radial acceleration of each wheel (2, 3, 5, 6) is computed so as to command measurements of the amplitudes of the carrier of the signals delivered by the tangential measurement sensors (16) only when said radial acceleration increases.

6. The location method as claimed in claim 5, characterized in that the radial acceleration of each wheel (2, 3, 5, 6) is computed by means of a measurement sensor (17) having an axis of maximum radial sensitivity.

7. The location method as claimed in claim 1, characterized in that it consists in measuring values representative of the rotation speed of the engine (M), and in comparing said measured values with values representative of the frequency of the carrier of the signals delivered by the tangential measurement sensors (16), so as to make the validation of said signals conditional upon a correlation between the compared values.

8. The location method as claimed in claim 1, characterized in that it consists in measuring values representative of the load of the engine (M), and in comparing said measured values with values representative of the amplitude of the carrier of the signals delivered by the tangential measurement sensors (16), so as to make the validation of said signals conditional upon a correlation between the compared values.

9. The location method as claimed in claim 3, characterized in that:
in a prior phase, in each electronic module (8-11), for each transmission ratio of the gearbox of the engine (M) of the vehicle (1), a frequency band is stored that is determined as a function of the value of said transmission ratio,
and when the vehicle (1) is running, the rotation speed of each wheel (2, 3, 5, 6) is computed so as to determine the corresponding transmission ratio of the gearbox, and the associated frequency band is selected for the purpose of measuring the amplitudes of the carrier of the signals delivered by the tangential measurement sensors (16).

10. The location method as claimed in claim 2, characterized in that the radial acceleration of each wheel (2, 3, 5, 6) is computed so as to command measurements of the amplitudes of the carrier of the signals delivered by the tangential measurement sensors (16) only when said radial acceleration increases.

11. The location method as claimed in claim 2, characterized in that it consists in measuring values representative of the rotation speed of the engine (M), and in comparing said measured values with values representative of the frequency of the carrier of the signals delivered by the tangential measurement sensors (16), so as to make the validation of said signals conditional upon a correlation between the compared values.

12. The location method as claimed in claim 2, characterized in that it consists in measuring values representative of the load of the engine (M), and in comparing said measured values with values representative of the amplitude of the carrier of the signals delivered by the tangential measurement sensors (16), so as to make the validation of said signals conditional upon a correlation between the compared values.
